(19) United States
(12) Patent Application Publication
(10) Pub. No.: US 2022/0307293 A1
(43) Pub. Date: Sep. 29, 2022

(54) STORAGE DEVICE

(71) Applicant: Max SELINGER, Ennetbaden (CH)

(72) Inventor: Max SELINGER, Ennetbaden (CH)

(21) Appl. No.: 17/639,037

(22) PCT Filed: Aug. 20, 2020
(86) PCT No.: PCT/EP2020/073423

§ 371 Date: Feb. 28, 2022

(30) Foreign Application Priority Data
Aug. 29, 2019 (DE) 10 2019 123 156.6

(51) Int. Cl. E05B 73/00; E05G 1/04; E05G 1/00

(52) U.S. Cl. CPC E05B 73/0023; E05G 1/04; E05G 1/005

(57) ABSTRACT

A storage device comprises a closable storage unit defining at least one storage space for personal items, and comprises a fastening unit, which is connected with the storage unit and which is configured for a fixation of the storage unit to at least one rod element.

The invention concerns a storage device for a storage and/or safeguarding of personal items according to claim 1.

A well-known problem with beach trips is the protection of personal items. Beach walkers wandering along the beach and/or swimming in the sea have problems with taking their personal items along, and are therefore forced to stow these personal items at their personal patch of beach. In order to avoid theft, the personal items are often hidden under a bath towel and/or under a piece of clothing. Even if the personal items are thus removed out of sight, this cannot prevent the personal items from getting quickly and furtively stolen. There are similar problems with bicycle tours and/or outdoor activities.

The objective of the invention is in particular to provide a device that allows a user to safely store personal items and to make theft of the personal items at least difficult. The objective is achieved according to the invention by the features of claim 1 while advantageous implementations and further developments of the invention may be gathered from the subclaims.

A storage device is proposed, with a closable, preferably lockable, storage unit defining at least one storage space for personal items, and with a fastening unit, which is in particular fixedly connected with the storage unit and which is configured for a fixation of the storage unit to at least one rod element, wherein the rod element may, for example, be a parasol rod or part of a vehicle rodding or part of a pull-out suitcase handle. It would also be conceivable that the rod element is part of camping equipment and/or outdoor equipment.

Such an implementation makes theft of personal items at least difficult. Advantageously theft of the storage unit can be made difficult as this would involve damaging the rod element and/or the fastening unit. It is particularly advantageously possible to make theft of the personal items time-consuming and conspicuous as an unauthorized person would have to deal, for example, with a parasol rod and/or a vehicle rodding in a visible and noisy fashion, thus possibly alerting an operator and/or nearby persons.

It would be conceivable that the storage unit defines a plurality of storage spaces. Preferentially the storage unit defines precisely one storage space and is particularly preferentially embodied as a housing that delimits the storage space. Advantageously the storage unit comprises at least one, preferably removable, partition wall within the storage space, which is configured to hold at least one personal item and which advantageously defines a compartment for the personal item. In particular, the storage unit is implemented in a substantially break-open-proof manner. By the storage unit being implemented “in a substantially break-open-proof manner” is in particular to be understood that, at least in a closed state of the storage unit, individual components of the storage unit adjoin each other in a substantially form-fit manner. Preferentially a width of gaps between the components of the storage unit is maximally 1 mm, particularly preferentially no more than 0.5 mm. In this way it is possible to avoid that the storage unit could be pierced by pointed objects, for example knives or screw-drivers, in the intention of breaking the storage unit open. The storage unit advantageously comprises an outer surface, which is in particular printable. This is in particular advantageous when using the storage device as a give-away article. Especially advantageously the storage unit has on its outer surface at least one inscribable area in which, for example, a name of the operator may be entered. Preferentially the storage unit comprises at least one, preferably lightweight and/or shockproof, material providing in particular a high level of carrying comfort and/or of safety for personal items which are located in the storage space. The storage unit could, for example, comprise stainless steel and/or aluminum and/or polycarbonate and/or ABS and/or PEEK and/or PEI.

In particular, the “personal items” comprise at least one mobile device, in particular a smartphone, and/or at least one jewelry item and/or at least one purse and/or a watch and/or at least one pair of spectacles and/or at least one spectacle case. Advantageously the personal items comprise exclusively items which can be carried on the body. By a “storage space for personal items” is in particular a space to be understood the dimensions of which are sufficiently large for receiving and storing any personal item, advantageously all personal items, of an operator which the operator takes on a trip. The personal items usually taken on a trip by an operator comprise a smartphone, a bunch of keys, a purse and a watch. Advantageously the storage space has a length of at least 14 cm, advantageously at least 16 cm, especially advantageously at least 18 cm, and a maximum width of at least 6 cm, advantageously at least 7 cm and especially advantageously at least 8 cm. Especially advantageously the storage space has a length of maximally 22 cm, advantageously maximally 20 cm and especially advantageously no more than 18 cm, and a maximum width of maximally 10 cm, advantageously maximally 9 cm and especially advantageously no more than 8 cm.

By the storage unit being “closable” is in particular to be understood that in a closed state of the storage unit, the storage space is completely delimited from an environment. Preferably the storage device, particularly preferentially the storage unit, comprises at least one closure for closing the storage space. For example, the storage device, in particular the storage unit, may comprise at least one rotary closure and/or at least one latch closure and/or at least one slidable closure and/or at least one magnet closure. In particular, the closure is fixedly integrated in the storage unit. Alternatively the closure could be embodied separately from the storage unit.

By the storage unit being “lockable” is in particular to be understood that the storage device, in particular the storage unit, comprises at least one closure that is releasable only by authorized persons. For example, the storage device, in particular the storage unit, may comprise at least one combination lock and/or at least one cylinder lock and/or at least one electronic lock and/or at least one further type of lock that is known to someone skilled in the art. In particular, the closure is releasable by means of a key and/or a key card and/or a chip and/or a combination of numbers. It would be conceivable that a closable storage unit can be refitted into a lockable storage unit.

It would be conceivable that the fastening unit and the storage unit are implemented separately from each other. Preferentially the fastening unit and the storage unit are implemented integrally with each other. “Integrally” is in particular to mean connected at least by substance-to-substance bond, for example via a welding process, a gluing process, an injection-molding process and/or any other process that is deemed expedient by someone skilled in the art, and/or advantageously formed in one piece, like for example by a production from a cast and/or by a production in a one-component or multi-component injection-molding procedure, and advantageously from a single blank. In particular, the fastening unit and the storage unit have at least one common wall element.

By a “rod element” is in particular an element to be understood for which a length of an imaginary rectangular cuboid that just still completely accommodates the object is equivalent to at least a five-fold, advantageously at least a ten-fold and especially advantageously at least a fifteen-fold of a height and a width of the rectangular cuboid. The rod element may, for example, be part of a parasol and/or of a pull-out suitcase handle and/or of a bicycle and/or of a boat and/or of a golf cart, in particular a golf trolley.

“Configured” is in particular to mean specifically designed and/or equipped. By an object being configured for a certain function is in particular to be understood that the object fulfills and/or executes said certain function in at least one application state and/or operation state. In particular, “configured” does not mean merely suitable.

It would be conceivable that the fastening unit is configured for a permanent fixation of the storage unit on the rod element, fastening the storage unit to the rod element, for example, by means of at least one glue connection and/or at least one welding connection and/or at least one other permanent connection known to someone skilled in the art. This would in particular be advantageous in the case of permanent applications in installations, like for example hotel pools and/or beach pools and/or parasol renting points.

Furthermore, the fastening unit may fasten the storage unit by sliding the fastening unit onto the rod element, and may in particular be releasable from the rod element via a demounting of the rod element. For the purpose of augmenting flexibility, it is proposed that the fastening unit is configured for a releasable fixation of the storage unit on the rod element, and comprises an unlocking unit for releasing the fixation and advantageously for a re-fixation of the storage unit. Preferably the fixation is manually releasable. Alternatively the fixation may be releasable by means of a tool. It is conceivable that the unlocking unit comprises at least one thread element and/or at least one latch element and/or at least one push button and/or at least one further unlocking element known to someone skilled in the art. This enables an exchangeable fixation of the storage device on different rod elements, thus providing high security independently from a location. Advantageously an operator may vary a position and an application area of the storage device individually. For example, when using the storage device on a parasol rod, a position close to the ground may be chosen, such that the storage device may be additionally covered with a bath towel and/or with a piece of clothing.

It is moreover proposed that the unlocking unit is operable, preferably exclusively operable, particularly preferably manually operable, from the storage space. By the unlocking unit being operable “from the storage space” is in particular to be understood that the unlocking unit is arranged at least partly within the storage space and/or at least one access is arranged within the storage space, which allows accessing the unlocking unit. In this way in particular safety can be further increased. Advantageously an unauthorized person having no access to an interior of the storage space can be prevented from releasing the fixation. It is especially advantageously possible to hamper a theft of the storage device brought about by the unauthorized person releasing the storage unit from the rod element. In particular, the unauthorized person will not be able to release the storage unit from the rod element quickly and furtively, not even using tools, e. g. screw-drivers.

Beyond this it is proposed that the fastening unit comprises at least one connection element, which is configured to engage around the rod element at least partly, in particular completely. Advantageously the connection element may engage around the rod element in a form-fit manner. Especially advantageously the connection element facilitates a fixation of the storage unit in different positions along a longitudinal direction of the rod element. The connection element may, for example, comprise at least one bracket, in particular a round bracket, and/or at least one latch element, in particular a latch tongue, and/or at least one string and/or a tape and/or at least one plug element, in particular a securing ring. This in particular allows achieving a simple and comfortable fastening of the storage unit to the rod element.

It would be conceivable that the connection element is configured to engage around a rod element having a pre-defined diameter. For further augmentation of flexibility, it is proposed that the connection element is adaptable to a diameter of the rod element. By the connection element being “adaptable to a diameter of the rod element” is in particular to be understood that the connection element is configured to fasten the storage unit on rod elements with different diameters. In particular, the connection element is capable of engaging around rod elements with a diameter of at least 19 mm, advantageously at least 21 mm, especially advantageously at least 23 mm and preferentially at least 25 mm, and of maximally 46 mm, advantageously maximally 44 mm, especially advantageously no more than 42 mm and preferentially no more than 40 mm. For example, the connection element may comprise at least one ratchet pawl, which is configured to adapt the connection element to a diameter of the rod element. Advantageously it is possible to fasten the storage unit to different types of rods, which allows providing a high degree of safety independently from an application area.

It is also proposed that the fastening unit comprises at least one basis element, which is implemented separately from the connection element. Alternatively the connection element could form the entire fastening unit. Preferentially the basis element is configured to provide a support of the connection element. Advantageously the connection element is supported movably relative to the basis element. This in particular allows further simplifying a fixation of the storage unit. Advantageously, the connection element is movable on the rod element relative to the basis element for a fastening of the storage unit.

It would be conceivable that the connection element is fixedly connected to the basis element. For the purpose of increasing flexibility and carrying comfort, it is proposed that the connection element is removable, preferably reversibly removable, from the basis element. Advantageously the connection element may be exchangeable for different further connection elements. Advantageously, the connection element is removable for a transport of the storage device, as a result of which a compactness of the storage device is increased. It is especially advantageously possible to provide the fastening unit with a suitable connection element depending on an application area.

Furthermore, it is proposed that the storage device comprises at least one receiving unit, which is in particular connected with the storage unit, in particular fixedly connected with the storage unit, and is configured to receive the connection element in a removed state. It would be conceivable that the receiving unit comprises at least one plug element and/or at least one tab for the connection element. Preferentially the receiving unit defines at least one storage space for the connection element. For example, the receiving unit may comprise at least one drawer and/or at least one screw top for a delimitation of the storage space. Particularly preferentially the receiving unit comprises at least one flap lid for a delimitation of the storage space. This in particular allows further increasing compactness and carrying comfort. Advantageously the connection element is stowable in a space-saving manner during a transport of the storage device.

Advantageously the fastening unit comprises a hinge unit, via which the connection element is connected to the basis element. Advantageously the hinge unit comprises at least one sub-element of the connection element, at least one sub-element of the basis element and at least one hinge bolt. Alternatively the hinge unit could be implemented separately from the connection element and/or the basis element. Preferably the storage device is transferable from a released state into a fastened state by a pivoting movement of the connection element. This in particular allows further simplifying a fixation of the storage unit. Advantageously it is possible to fasten the storage unit to the rod element by an intuitive movement.

In addition it is proposed that the connection element comprises at least one screw thread. It would be conceivable that the connection element is screwable into the basis element of the fastening unit and/or into the storage unit. Preferentially the fastening unit comprises at least one screw nut, which is screwable onto the screw thread. Particularly preferentially the storage unit and the fastening unit have at least one common pair of holes, which is configured to at least partially receive the connection element and to allow the connection element entering the storage space. Preferably the screw nut is arranged within the storage space, at least in a screwed-on state. Advantageously the connection element is adaptable to a diameter of the rod element by turning the screwed-on screw nut. This in particular allows improving an engagement of the connection element around the rod element. Advantageously screwing the connection element tightly will ensure a firm engagement around the rod element. Especially advantageously precise adaption of the connection element to a diameter of the rod element can be provided by way of the screw thread.

It would be conceivable that the storage unit has any basic shape and is possible deformable. In order to enhance comfort when carrying the storage device and when storing personal items, it is proposed that the storage unit has an at least substantially cylindrical basic shape. By the storage unit having an “at least substantially cylindrical basic shape” is in particular to be understood that a spatial volume filled by the storage unit is capable of completely accommodating at least an imaginary ideal general cylinder whose volume is at least 70%, advantageously at least 80% and especially advantageously at least 90% of the spatial volume. For example, the ideal general cylinder may be an oval cylinder or preferentially a circular cylinder. The storage space preferably has an at least substantially cylindrical basic shape. Advantageously an edge-free implementation of the storage unit is achievable, thus avoiding an uncomfortable carrying feeling during a transport of the storage unit. Particularly advantageously it is possible to make effective use of the storage space for a stowage of elongate personal items, like wallets, spectacles, spectacle cases and smartphones.

It is further proposed that the storage unit has a body with at least one access opening as well as at least one closure element for closing the access opening, the closure element being pivotable relative to the body around a rotation axis that is parallel to a longitudinal extension direction of the body. By a “body” is in particular an element to be understood which defines a carrying base structure and which preferentially defines an inner space at least partially. In particular, together with the closure element, the body surrounds the storage space completely in a closed state of the storage unit. Preferentially the closure element is embodied as a back-foldable envelope part of a storage unit having an at least substantially cylindrical basic shape. Advantageously the access opening has a height and a width corresponding at least to a height and a width of any mobile device, in particular of a smartphone. Especially advantageously the access opening has a height of at least 14 cm, advantageously at least 16 cm, especially advantageously at least 18 cm, and has a maximum width of at least 6 cm, advantageously at least 7 cm and especially advantageously at least 8 cm. The closure element and the body preferably have corresponding projections which together define a passage. The passage is in particular configured to receive a portion of a lock for locking the storage unit. In this way in particular comfortable stowage of the personal items is achievable. Advantageously easy access to an interior of the storage space is achievable for the purpose of stowage and removal of the personal items.

In particular, the storage space has a volume of maximally 1,200 cm³, advantageously maximally 1,100 cm³, particularly advantageously no more than 1,000 cm³ and preferentially no more than 900 cm³. In particular, the storage device differs from suitcases and cupboards. As a result, in particular carrying comfort and stowage comfort are augmentable. Advantageously the storage device may be implemented in a compact manner and may, for example, be transportable in a hand. Especially advantageously the storage space may be implemented having dimensions which are sufficient for a storage of mobile devices.

The storage device may possibly be transportable exclusively by hand. In order to further increase a carrying comfort, it is proposed that the storage device comprises at least one carrying member, which is connected to the storage unit and/or to the fastening unit at least in a fastened state, and is configured for the storage unit being carried by an operator. For example, the carrying member may be embodied as a strap and/or as a tab and/or as a handle and/or as a clasp. The storage device can in particular be carried in a hand or on a back. It would be conceivable that the storage device can be carried on a waistbelt. Preferentially the storage unit and/or the fastening unit have/has at least one holder for the carrying member. The holder may, for example, be realized as a plug element and/or as a holding bar and/or as a snap element and/or as a projection with at least one passage. Preferably the carrying member is fastened to the holder releasably. Preferably the storage device can be equipped optionally with different carrying members.

Beyond this it is proposed that the storage device comprises a protective unit, which is configured for a protection of the personal items in the storage space. The protective unit may comprise, for example, at least one damping material, in particular foam, which is arranged within the storage space and protects the personal items from shock. The protective unit may further comprise at least one protective layer, which is part of the storage unit and may for example be realized as a, preferably reflecting, heat insulation layer and/or as a shock-protection layer, in particular on an outer side of the storage unit. Alternatively or additionally, the protective unit may comprise a, preferably water-tight, protective sleeve, which is arranged within the storage space and is configured for receiving at least one personal item. It would also be conceivable that the protective unit comprises a sealing, preferentially a closure sealing, which is preferentially arranged on the closure element and prevents—in a closed state of the storage unit—entry of liquids and/or sand into the storage space. This in particular allows further augmenting safety. Advantageously a damaging of the personal items in the storage space can be avoided.

It would be conceivable that the protective unit comprises at least one alert unit. By an “alert unit” is in particular a unit to be understood which emits an optical and/or acoustical signal to alert an operator in the case of unauthorized opening of the storage unit and/or of unauthorized releasing of the storage unit from the rod element. In particular, the alert unit may comprise a power source, which is preferably integrated in the storage unit and which may, for example, comprise at least one battery and/or at least one accumulator and/or at least one solar cell. The alert unit could, for example, comprise at least one input unit, for example a keypad, which is arranged within the storage space and is configured for an input of an identification code by the operator. In particular, the alert unit may upon an opening of the storage unit activate a countdown, which can be interrupted by entering the identification code into the input unit, wherein the alert unit emits the signal when the countdown has finished. It would also be conceivable that the alert unit is integrated in a lock of the storage device and emits the signal when the lock is broken open.

Furthermore a system is proposed with the storage device and with the rod element, which is in particular realized as a parasol rod and/or as part of a vehicle rodding. The rod element could, for example, be part of a bicycle and/or of a boat and/or of a golf cart, in particular a golf trolley. This in particular allows increasing safety with storage of personal items.

The storage device shall herein not be limited to the application and implementation described above. In particular, for the purpose of fulfilling a functionality that is described here, the storage device may comprise a number of individual elements, components and units that differs from a number given here.

Further advantages will become apparent from the following description of the drawings. In the drawings three exemplary embodiments of the invention are illustrated. The drawings, the description and the claims contain a plurality of features in combination. Someone skilled in the art will purposefully also consider the features individually and will find further expedient combinations.

It is shown in:

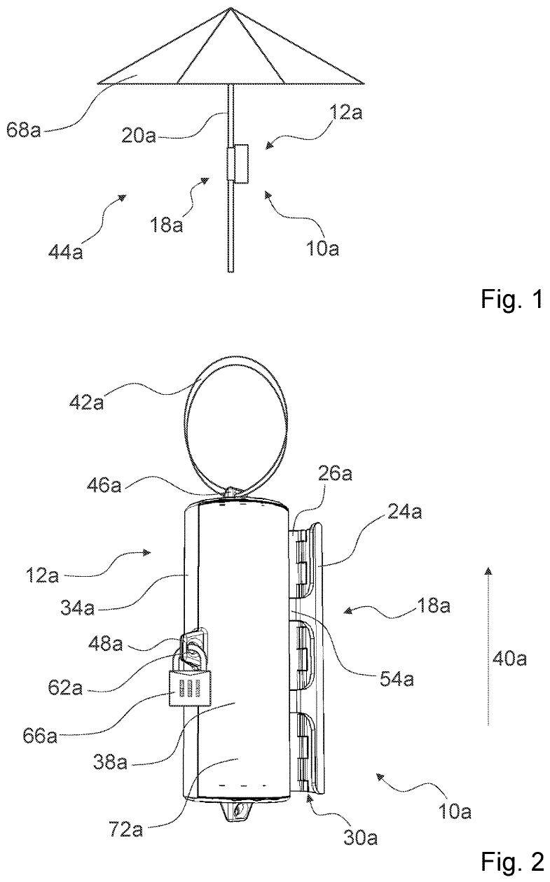

FIG. 1 a schematic illustration of a system with a parasol and with a storage device,

FIG. 2 a schematic illustration of the storage device in a front view,

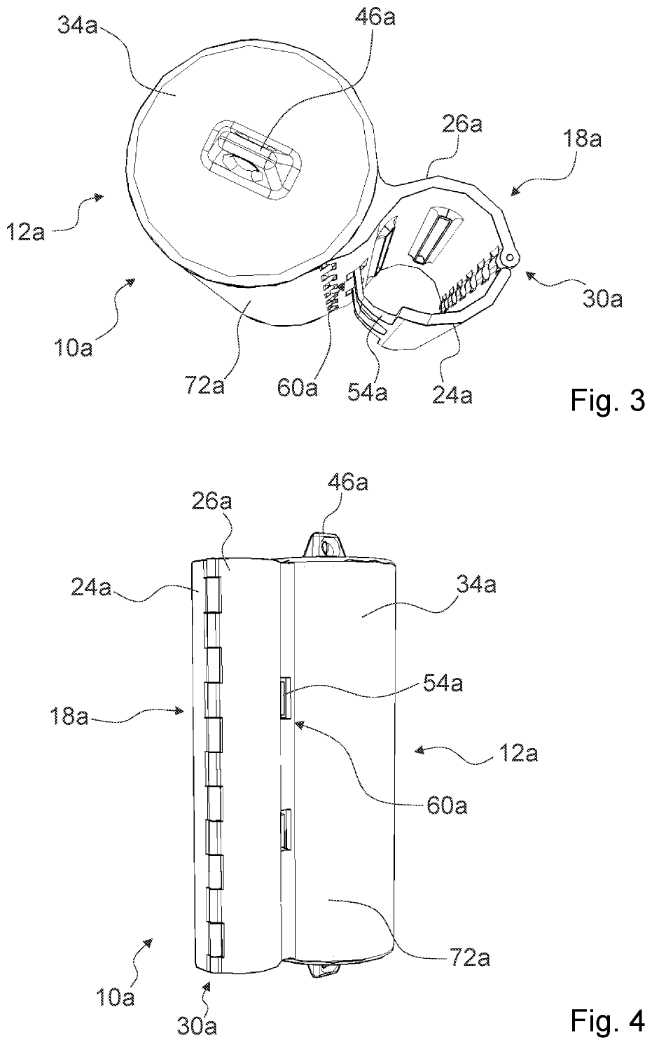

FIG. 3 a schematic illustration of the storage device in a top view,

FIG. 4 a schematic illustration of the storage device in a rear view,

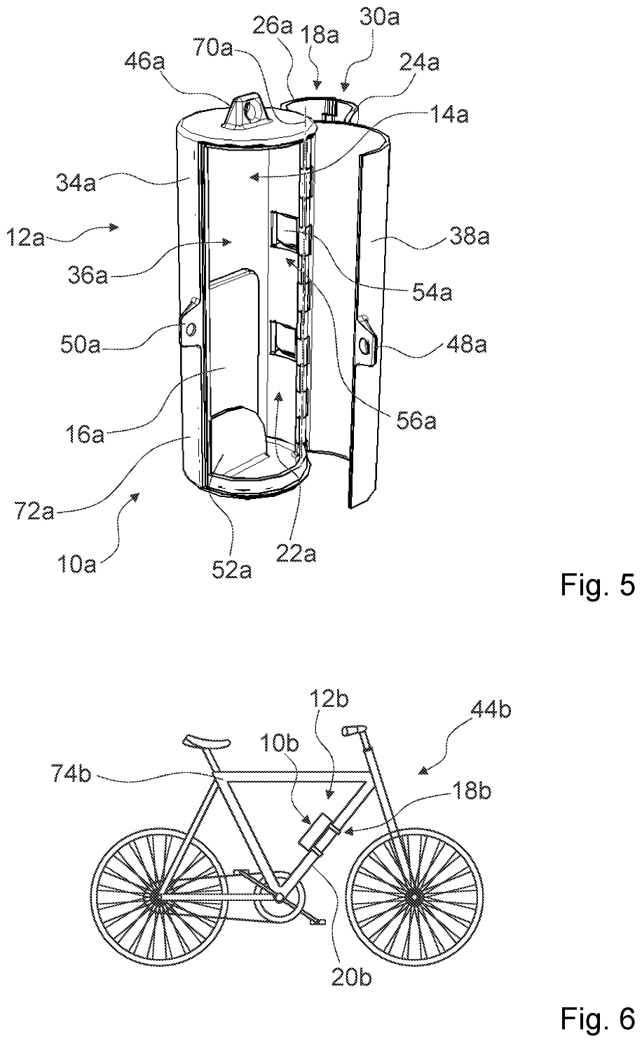

FIG. 5 a schematic illustration of the storage device in an open state in a front view,

FIG. 6 a schematic illustration of a further exemplary embodiment of a system with a bicycle and with a storage device,

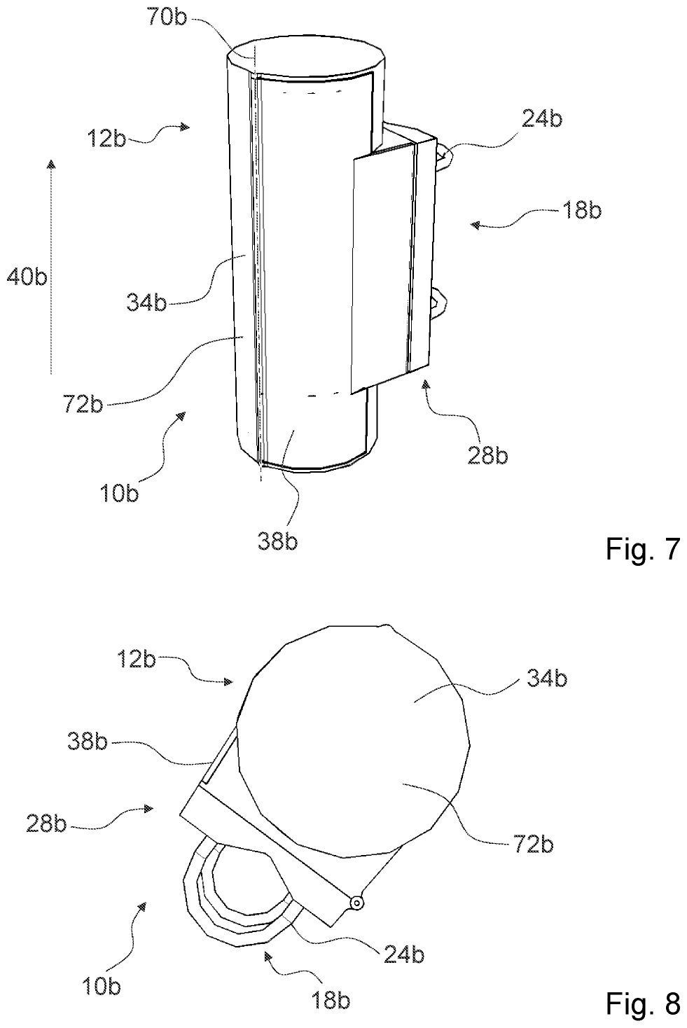

FIG. 7 a schematic illustration of the storage device of FIG. 6 in a front view,

FIG. 8 a schematic illustration of the storage device of FIG. 6 in a top view,

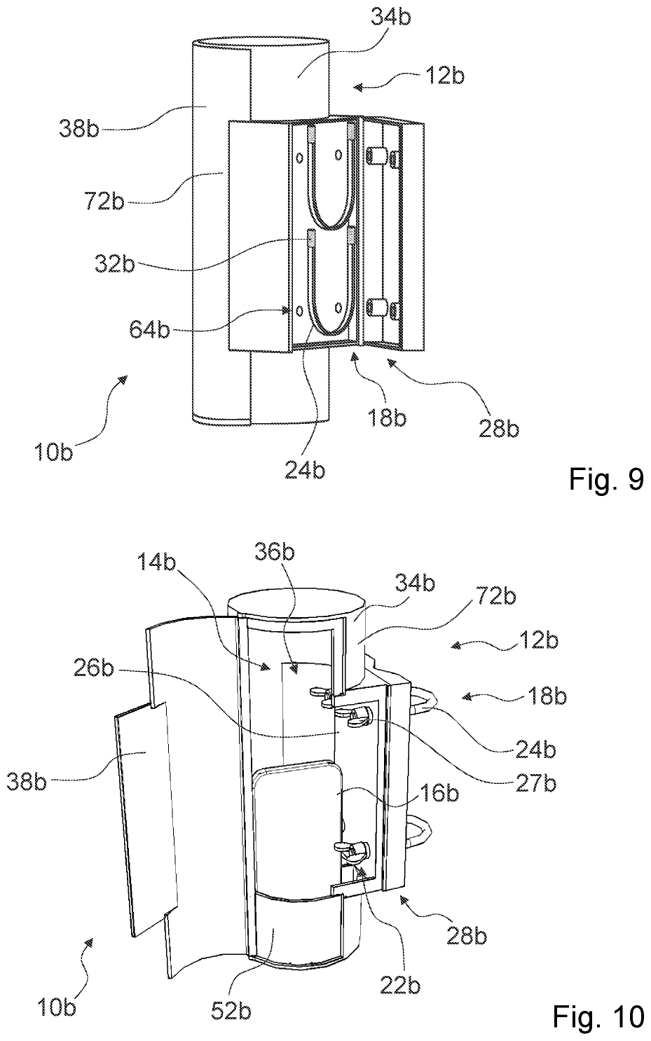

FIG. 9 a schematic illustration of the storage device of FIG. 6 with a storage unit in an open state in a front view,

FIG. 10 a schematic illustration of the storage device of FIG. 6 in an open state in a front view,

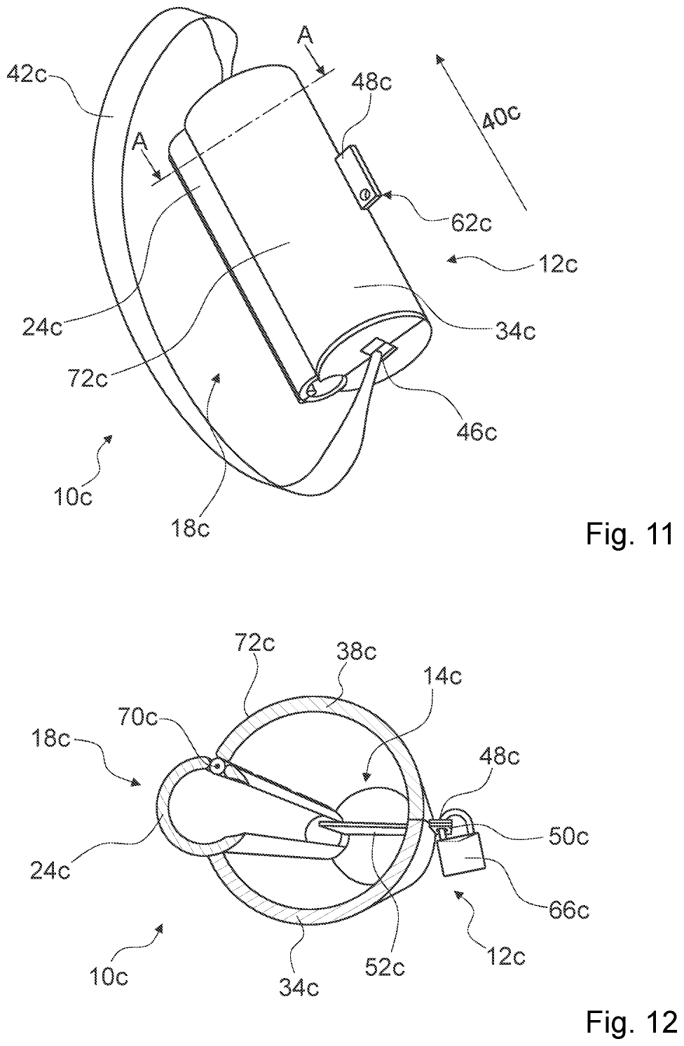

FIG. 11 a schematic illustration of an alternative exemplary embodiment of a storage device in an oblique front view, and

FIG. 12 a schematic sectional view of the storage device of FIG. 11.

If there are a plurality of objects, in each case only one of such objects is provided with a reference numeral in the figures.

FIG. 1 shows a system 44a with a parasol 68a. The system 44a comprises a storage device 10a. The parasol 68a comprises a rod element 20a. The rod element 20a is embodied as a parasol rod. The storage device 10a is embodied as a device for a secure storage of personal items. FIGS. 2 to 5 show different views of the storage device 10a.

The storage device 10a comprises a storage unit 12a. The storage unit 12a is lockable. The storage unit 12a defines a storage space 14a. The storage space 14a is configured to receive a personal item 16a, which is exemplarily shown in FIG. 5. In the present case the personal item 16a is embodied as a smartphone. Alternatively or additionally the storage space 14a may accommodate further personal items. For this purpose the storage space 14a has a volume of approximately 900 cm³. The storage unit 12a has a partition wall 52a. The partition wall 52a serves for holding the personal item 16a.

The storage unit 12a has a substantially cylindrical basic shape. Alternatively the storage unit 12a could have a substantially rectangular-cuboidal basic shape. The storage unit 12a comprises at least one of any lightweight, shock-proof materials known to someone skilled in the art; the storage unit 12a could for example contain aluminum. The storage unit 12a comprises a body 34a. The body 34a has an access opening 36a. The storage unit 12a comprises a closure element 38a. The closure element 38a serves for a closure of the access opening 36a. In a closed state of the storage unit 12a, the closure element 38a covers the access opening 36a completely. The closure element 38a is pivotable relative to the body 34a around a rotation axis 70a that is parallel to a longitudinal extension direction 40a of the body 34a.

The body 34a has a first projection 48a. The closure element 38a has a second projection 50a. The first projection 48a and the second projection 50a are arranged neighboring each other. The first projection 48a and the second projection 50a have recesses which together define a pass-through 62a. The storage device 10a comprises a lock 66a. The lock 66a is implemented as a combination lock. The pass-through 62a accommodates a portion of the lock 66a. The lock 66a serves for locking the storage unit 12a.

The storage device 10a comprises a carrying member 42a. The carrying member 42a is realized as a holding loop. The carrying member 42a is configured for a carrying of the storage unit 12a by an operator. The carrying member 42a is configured to facilitate a transport of the storage device 10a in a hand. In a fastened state the carrying member 42a is connected to the storage unit 12a. The storage unit 12a comprises two holders 46a, which are arranged opposite each other on an upper side and an underside of the storage unit 12a and which are identical to each other, which is why only one of the holders 46a will be described in the following. The holder 46a is realized as a projection. The holder 46a comprises a recess. The holder 46a serves for a fixation of the carrying member 42a. The carrying member 42a is passed through the recess of the holder 46a. Alternatively, the carrying member 42a could in the fastened state be connected to the fastening unit 18a or to the storage unit 12a and to the fastening unit 18a.

The storage device 10a comprises a protective unit 72a. The protective unit 72a is configured for a protection of the personal item 16a in the storage space 14a. The protective unit 72a is embodied as a reflecting heat insulation layer. The protective unit 72a forms an outer surface of the storage unit 12a. The protective unit 72a protects the personal item 16a in the storage space 14a from heat and cold damages.

The storage device 10a comprises a fastening unit 18a. The fastening unit 18a is fixedly connected with the storage unit 12a. The fastening unit 18a is configured for a fixation of the storage unit 12a on the rod element 20a. The fastening unit 18a is configured for a releasable fixation of the storage unit 12a on the rod element 20a. The fastening unit 18a comprises an unlocking unit 22a. The unlocking unit 22a serves for releasing the fixation.

The unlocking unit 22a comprises two latch tongues 54a which are identical to each other, which is why only the latch tongue 54a will be described in the following. Alternatively the unlocking unit 22a could comprise any other number of latch tongues. The latch tongue 54a has a toothing (not shown). In a latched-in state, the latch tongue 54a provides the fixation of the storage unit 12a on the rod element 20a. The unlocking unit 22a is operable only from the storage space 14a. The storage unit 12a comprises openings 56a, which are shown in FIG. 5 and are identical to each other, which is why only one of the openings 56a will be described in the following. The opening 56a is arranged within the storage space 14a. The opening 56a permits access to the latch tongue 54a from the storage space 14a. An operator may transfer the latch tongue 54a from a latched-in state into a released state by pressing the latch tab 54a out of the storage space 14a.

The fastening unit 18a comprises a connection element 24a. Alternatively or additionally the fastening unit 18a may comprise further connection elements. The connection element 24a is configured to partly engage around the rod element 20a. The connection element 24a supports the latch tongue 54a. The fastening unit 18a comprises a basis element 26a. The basis element 26a is realized separately from the connection element 24a. The basis element 26a supports the connection element 24a.

The fastening unit 18a comprises a hinge unit 30a. The connection element 24a is connected to the basis element 26a via the hinge unit 30a. The hinge unit 30a comprises a sub-element of the connection element 24a. The hinge unit 30a comprises a sub-element of the basis element 26a. The sub-element of the connection element 24a and the sub-element of the basis element 26a are realized so as to engage into each other. The hinge unit 30a comprises a hinge bolt 58a, which is shown in FIG. 3. The hinge bolt 58a penetrates the sub-element of the connection element 24a and the sub-element of the basis element 26a and couples the two sub-elements with each other. The hinge unit 30a defines a rotation axis which the connection element 24a is pivotable around.

The connection element 24a is adaptable to a diameter of the rod element 20a. The fastening unit 18a has two latch holes 60a which are identical to each other, which is why only one of the latch holes 60a will be described in the following. A pivoting movement of the connection element 24a makes the latch tongue 54a enter the latch hole 60a. Depending on a length of the pivoting movement, the latch tongue 54a will get latched in different positions. The different positions permit the connection element 24a to engage around rod elements with different diameters.

In FIGS. 6 to 12 two further exemplary embodiments of the invention are shown. The following descriptions are essentially limited to the differences between the exemplary embodiments, wherein regarding components, features and functions that remain the same, the description of the exemplary embodiment of FIGS. 1 to 5 may be referred to. In order to distinguish between the exemplary embodiments, the letter a added to the reference numerals of the exemplary embodiment of FIGS. 1 to 5 has been substituted by the letter b in the reference numerals of the exemplary embodiment of FIGS. 6 to 10 and by the letter c in the reference numerals of the exemplary embodiment of FIGS. 11 and 12. Regarding components having the same denomination, in particular regarding components having the same reference numerals, the drawings and/or the description of the exemplary embodiment of FIGS. 1 to 5 may principally be referred to.

FIG. 6 shows a system 44b with a bicycle 74b. The system 44b comprises a storage device 10b. The bicycle 74b comprises a rod element 20b. The rod element 20b is part of a bicycle rodding. FIGS. 7 to 10 show different views of the storage device 10b.

While the storage device 10b dispenses with a carrying member, holders for the carrying member and a lock for locking a storage unit 12b of the storage device 10b, it is principally refittable with these components. The storage device 10b comprises a fastening unit 18b with two connection elements 24b and two basis elements 26b which are respectively identical to each other, which is why only one connection element 24b and one basis element 26b will be described in the following. The connection element 24b is embodied as a round bracket. The connection element 24b comprises two screw threads 32b. The screw threads 32b are arranged in end regions of the connection element 24b.

The fastening unit 18b comprises a basis element 26b. The basis element 26b is embodied integrally with the storage unit 12b. The fastening unit 18b comprises a screw nut 27b. The screw nut 27b is realized as a butterfly nut. The screw nut 27b has a counter-thread (not shown) that corresponds to the screw threads 32b. The storage unit 12b and the fastening unit 18b have corresponding pairs of holes, which together define pass-throughs 64b that are identical to each other, which is why only one of the pass-throughs 64b will be described in the following. In a fastened state of the storage device 10b, one of the end regions of the connection element 24b penetrates the pass-through 64b and protrudes into a storage space 14b of the storage unit 12b. The connection element 24b, the storage unit 12b and the fastening unit 18b are made of metal. Alternatively it would be conceivable that only the connection element 24b is made of metal and the storage unit 12b and the fastening unit 18b are, for example, made of a synthetic material and respectively comprise metal inlays defining the corresponding pairs of holes. In this way damaging of the storage unit 12b and the fastening unit 18b by the connection element 24b can be avoided.

In the fastened state of the storage device 19b the screw nut 27b is arranged within the storage space 14b and is screwed onto one of the end regions of the connection element 24b. The connection element 24b is adaptable to a diameter of a rod element 20b by turning the screwed-on screw nut 27b. The connection element 24b is removable from the basis element 26b. The connection element 24b is removable from the basis element 26b in a state when the screw nut 27b has been screwed off.

The storage device 10b comprises a receiving unit 28b. The basis element 26b supports the receiving unit 28b. The receiving unit 28b is configured to accommodate the connection element 24b in a removed state. The receiving unit 28b defines a stowage space for a stowage of the connection element 24b in a removed state of the connection element 24b. The receiving unit 28b has a flap lid. The flap lid closes the stowage space in a closed state of the receiving unit 28b.

FIG. 11 illustrates an alternative exemplary embodiment of a storage device 10c. FIG. 12 shows the storage device 10c in a sectional view along a section plane A that is indicated in FIG. 11. The storage device 10c comprises a fastening unit 18c. The fastening unit 18c comprises a connection element 24c. The connection element 24c is realized in a tube shape. The connection element 24c comprises the entire fastening unit 18c. The storage device 10c is slidable onto a rod element (not shown) having a pre-defined diameter. The fastening unit 18c comprises removable covers (not shown). The removable covers are implemented as plate elements. The removable covers are configured, in a released state of the storage device 10c, to be arranged on an upper side and an underside of the fastening unit 18c, covering open ends of the fastening unit 18c. The removable covers serve for a protection of the fastening unit 18c from dirt entering in a released state of the storage device 10c. The storage device 10c comprises a carrying member 42c. The carrying member 42c is embodied as a carrying strap. The carrying member 42c is configured to facilitate a transport of the storage device 10c on a back. The storage device 10c comprises a storage unit 12c. The storage unit 12c comprises two holders 46c. The holders 46c are embodied as holding bars. The carrying member 42c is wrapped around the holders 46c. The storage device 10c comprises a lock 66c. The lock 66c is realized as a padlock.

### REFERENCE NUMERALS

10 storage device
12 storage unit
14 storage space
16 personal item
18 fastening unit
20 rod element
22 unlocking unit
24 connection element
26 basis element
27 screw nut
28 receiving unit
30 hinge unit
32 screw thread
34 body
36 access opening
38 closure element
40 longitudinal extension direction
42 carrying member
44 system
46 holder
48 first projection
50 second projection
52 partition wall
54 latch tongue
56 opening
58 hinge bolt
60 latch hole
62 passage
64 pass-through
66 lock
68 parasol
70 rotation axis
72 protective unit
74 bicycle

1. A storage device with a closable storage unit defining at least one storage space for personal items, and with a fastening unit, which is connected with the storage unit and which is configured for a fixation of the storage unit to at least one rod element.

2. The storage device according to claim 1, wherein the fastening unit is configured for a releasable fixation of the storage unit on the rod element, and comprises an unlocking unit for releasing the fixation.

3. The storage device according to claim 2, wherein the unlocking unit is operable, preferably exclusively operable, from the storage space.

4. The storage device according to claim 1, wherein the fastening unit comprises at least one connection element, which is configured to engage around the rod element at least partly.

5. The storage device according to claim 4, wherein the connection element is adaptable to a diameter of the rod element.

6. The storage device according to claim 4, wherein the fastening unit comprises at least one basis element, which is implemented separately from the connection element.

7. The storage device according to claim 6, wherein the connection element is removable from the basis element.

8. The storage device according to claim 6, comprising at least one receiving unit, which is configured to receive the connection element in a removed state.

9. The storage device according to claim 6, wherein the fastening unit comprises a hinge unit via which the connection element is connected to the basis element.

10. The storage device according to claim 4, wherein the connection element comprises at least one screw thread.

11. The storage device according to claim 1, wherein the storage unit has an at least substantially cylindrical basic shape.

12. The storage device according to claim 1, wherein the storage unit comprises at least one body with at least one access opening and comprises at least one closure element for closing the access opening, the closure element being pivotable relative to the body around a rotation axis that is parallel to a longitudinal extension direction of the body.

13. The storage device according to claim 1, wherein the storage space has a volume of maximally 1,200 cm³.

14. The storage device according to claim 1, comprising at least one carrying member, which is connected to the storage unit and/or to the fastening unit at least in a fastened state, and is configured for the storage unit being carried by an operator.

15. The storage device according to claim 1, comprising a protective unit, which is configured for a protection of the personal items in the storage space.

16. A system with a storage device according to claim 1 and with the rod element.
